(19) United States
(12) Patent Application Publication
(10) Pub. No.: US 2015/0371169 A1
(43) Pub. Date: Dec. 24, 2015

(54) METHOD AND SYSTEM FOR DESIGNING A DATA MARKET EXPERIMENT

(71) Applicant: THOMSON LICENSING, Issy de Moulineaux (FR)

(72) Inventors: Stratis IOANNIDIS, San Francisco, CA (US); Thibaut Y. Horel, Somerville, MA (US)

(21) Appl. No.: 14/765,002

(22) PCT Filed: Dec. 16, 2013
(86) PCT No.: PCT/US13/75468

§ 371 Date: Jul. 31, 2015

Related U.S. Application Data
(60) Provisional application No. 61/759,203, filed on Jan. 31, 2013.

(51) Int. Cl. G06Q 10/06; G06Q 30/02

(52) U.S. Cl. CPC G06Q 10/06313; G06Q 30/0201

(57) ABSTRACT

An apparatus and a method for designing a data market experiment given a fixed budget and a set of potential subjects for the experiment are described. An experimenter human subject, or any other kind of experiment through which it collects data, and can incentivize the participation of subjects in the experiment through monetary compensation. The experimenter observes some publicly known information about the subjects, as well as the money each potential subject requests to participate in the experiment. Based on this information, the method determines which users to pay, and how much, to participate in the experiment. The method views experimental design in a strategic setting, by studying mechanism design issues, such as incentivizing users to report a truthful value for their data. The method has the following properties of being budget feasible, computationally tractable, nearly-optimal, and truthful in that the subjects have no incentive to declare desired compensations that are untruthful.

### CROSS-REFERENCE TO RELATED APPLICATIONS

This application claims the benefit of U.S. Provisional Application Ser. No. 61/759,203, filed Jan. 31, 2013, which is incorporated by reference herein in its entirety.

### TECHNICAL FIELD

The present principles relate to an apparatus and method for designing a data market experiment.

### BACKGROUND OF THE INVENTION

In the field of experimental design, an experimenter may have access to a population of n potential experiment subjects. Each subject is associated with a set of features, known to the experimenter, such as gender, age, weight, profession, for example. The experimenter wishes to perform an experiment that measures a certain inherent property of the subjects, for example, their likelihood to click on an advertisement, contract a disease, or have high blood pressure. The outcome for a subject is unknown to the experimenter before the experiment is performed, but often the experimenter has a hypothesis of the relationship between the user features and the outputs, which the experimenter wishes to verify through the experiment. Conducting the experiments and obtaining the measurements lets the experimenter determine the validity of this hypothesis.

The above experimental design scenario has many applications, including medical testing, marketing research, online surveys, and others. In the description herein it is assumed that experiments cannot be manipulated and hence measurements are considered reliable. However, there is a cost associated with experimenting on each subject, which varies from subject to subject. This may be viewed as the cost the subject incurs when tested and for which the subject needs to be reimbursed; or, it might be viewed as the incentive for the subject to participate in the experiment; or, it might be the inherent value of the data.

There are a number of known estimation procedures, as well as methodologies for quantifying the quality of the produced estimate. There is also an extensive theory on how to select subjects if an experimenter can conduct only a limited number of experiments, so the estimation process returns approximate the true parameter of the underlying population. The principles described herein depart from this classical setup by viewing experimental design in a strategic setting, and by studying mechanism design issues, such as incentivizing users to report a truthful value for their data.

Experimenters often work with strict budgets, but often the subjects are strategic, meaning that they may have an incentive to misreport their desired compensation in efforts to maximize their monetary gain. A principled study of this problem from a strategic point of view has previously not been well known.

Budget feasible mechanism design was originally proposed in a first prior art approach. This approach considers the problem of maximizing an arbitrary submodular function, subject to a budget constraint in the value query model, i.e. assuming an oracle providing the value of the submodular objective on any given set. The first prior art approach shows that there exists a randomized, 112-approximation mechanism for submodular maximization that is universally truthful (i.e., it is a randomized mechanism sampled from a distribution over truthful mechanisms). A second prior art approach improves this result by providing a 7.91-approximate mechanism, and shows a corresponding lower bound of 2 among universally truthful mechanisms for submodular maximization. In contrast to the above results, no truthful, constant approximation mechanism that runs in polynomial time is presently known for submodular maximization. The present principles address the issue of incentivizing potential subjects to accurately report their desired compensation while determining a set of subjects and compensation for an experiment.

### SUMMARY OF THE INVENTION

These and other drawbacks and disadvantages of the prior art are addressed by the present principles, which are directed to methods and apparatus for designing a data market. The present principles provide methods in which an experimenter with a budget can design an experiment with subjects, each having a cost, such that the subjects are added to the experiment based on their value to the experiment and their cost.

According to an aspect of the present principles, there is provided a method for accessing a vector of features of at least one subject, comprising a cost of the at least one subject to participate in the experiment, receiving a budget describing cost to spend for the experiment, computing a value for each member of the set of subjects to the experiment to determine the highest value member of the set and adding this member to the experiment, performing convex optimization on subjects in the set other than the highest value member of the set to determine a threshold, comparing the threshold to the computed value to determine whether the computed value exceeds the threshold, and if so, assigning compensation to the at least one subject with the entire budget, and if the computed value does not exceed the threshold, assigning portions of the budget proportionally to subjects added to the experiment in increasing order of their marginal contribution to value of the experiment until the budget is exhausted.

According to another aspect of the present principles, there is provided an apparatus comprising one or more processors for selecting subjects from a set for an experiment, the processors collectively configured to: access a vector of features of at least one subject, comprising a cost of the at least one subject to participate in the experiment; receive a budget describing a cost to spend for the experiment, compute a value for each member of the set of subjects to the experiment to determine the highest value member of the set and adding this member to the experiment, perform convex optimization on subjects in the set other than the highest value member of the set to determine a threshold, compare the threshold to the computed value to determine whether the computed value exceeds the threshold, and if so, assign compensation to the at least one subject with the entire budget, and if the computed value does not exceed the threshold, assign portions of the budget proportionally to subjects added to the experiment in increasing order of their marginal contribution to value of the experiment until the budget is exhausted.

These and other aspects, features and advantages of the present principles will become apparent from the following detailed description of exemplary embodiments, which are to be read in connection with the accompanying drawings.

### BRIEF DESCRIPTION OF THE DRAWINGS

FIG. 1 shows one embodiment of a method for designing a data market using the present principles.

FIG. 2 shows one embodiment of an apparatus for designing a data market using the present principles.

### DETAILED DESCRIPTION OF THE INVENTION

The principles described herein are directed to a method and apparatus for designing a data market experiment. In at least one embodiment, a polynomial time truthful mechanism for the Experimental Design Problem (EDP) is provided.

The present invention proposes a method through which an experimenter conducting an online survey, for example, or a test on human subject, or any other kind of experiment through which it collects data, can incentivize the participation of subjects in the experiment through monetary compensation. The invention observes some publicly known information about the subjects (e.g., their age, gender, etc.) as well as the money each potential subject requests to participate in the experiment. Based on this information, the invention determines which users to pay, and how much, to participate in the experiment. In the explanation which follows, the present principles are described in the context of an experiment in which subjects are paid money to be included in the experiment, but one of skill in the art will realize that the principles described herein are applicable to other data markets that are within the scope of these principles.

The disclosed embodiments enable the execution of an experiment, for which the corresponding users carry a certain cost. In one described arrangement, an experimenter interacts with a set of users, whose data the experimenter wishes to obtain and process. Users have a set of public attributes, that are viewable by the experimenter, and a hidden attribute, that is revealed only after the experiment is concluded. For example, the public attributes can be demographic information such as age, gender, etc. The experiment can be the completion of an online survey, a rating to a movie, a blood sample, a medical test, or any such experiment, and the hidden variable would then be the completed entry in the form, the values measured in the sample, or other similar result.

The experimenter's goal is to perform a statistical operation, known as linear regression, to learn the mathematical relationship that correlates the experiment measurement (e.g., movie rating, blood pressure) to the public variables (age, gender, etc.). This can be useful in predicting the hidden variable to other sets of individuals, such as curing a disease, for example. However, the subjects of the experiment are not willing to participate in the experiment unless they are incentivized to do so through the form of a monetary compensation. The experimenter has a budget, and wishes to decide how to spend it, that is, which subjects to pay in order to conduct the experiment.

One embodiment of the present principles is a method that receives the following inputs
(a) The budget of the experimenter
(b) The public features of the subjects (their desirable compensation)
   and outputs
(a) A set of subjects, over which the experiment will be conducted
(b) The amount of money the experimenter will pay each subject participating in the experiment (this must necessarily be larger than their desirable compensation)

The disclosed method has the following properties
(a) It is budget feasible: the amount paid to subjects that participate in the experiment is within the budget devoted to the experiment.
(b) It is computationally tractable: all operations involved can be computed in polynomial time.
(c) It is nearly-optimal: it selects a set of subjects such that, after the experimenter performs linear regression on the data, the result is close to the best possible given the budget.
(d) It is truthful: subjects have no incentive to “game” the system and declare different compensations than the ones they actually want. This prevents them from proposing high compensations, and attempting to force the experimenter to pay them large sums of money.

The method herein described operates by assigning a value, referred to in literature as the D-optimality criterion, to each possible set of subjects. This value captures how accurate the linear regression operation will be once applied to this set of subjects. The algorithm for selecting the set of subjects is then as described in Algorithm 1. The process first selects the user in the dataset that has the highest value to the experimenter. It then performs a mathematical operation called convex optimization on the remaining subjects, computing a threshold value (denoted by the Greek letter xi in Algorithm 1). If the value of the most valuable user is above this threshold, the method pays the entire budget to this subject. If not, the algorithm constructs a set of subjects to compensate greedily, by adding one subject at a time: the subject added each time is the one that has the highest ratio between how much it contributes to the set of subjects selected so far (based on the D-Optimality criterion) and her desirable compensation. Finally, subjects are paid according to the rule known to those skilled in the art as “threshold payments”: the subjects are paid the highest possible payments that they could set as desirable compensation, and still be selected by the greedy algorithm.

In the classic setting of experimental design, an experimenter has access to a population of n potential experiment subjects. Each subject is associated with a set of parameters (or features), known to the experimenter (e.g., gender, age, weight, profession, etc.). The experimenter wishes to perform an experiment that measures a certain inherent property of the subjects (e.g., their likelihood to click on an advertisement, contract a disease, have high blood pressure etc.), but the outcome for a subject is unknown to the experimenter before the experiment is performed. Typically, the experimenter has a hypothesis of the relationship between the user features and the outputs (e.g., that high blood pressure correlates with weight) which they wish to verify through the experiment. Conducting the experiments and obtaining the measurements lets the experimenter determine the validity of this hypothesis.

The above experimental design scenario has many applications, including medical testing, marketing research, online surveys, and others. In the setting described here, experiments cannot be manipulated and hence measurements are considered reliable. However, there is a cost associated with experimenting on each subject, which varies from subject to subject. This may be viewed as the cost the subject incurs when tested and for which she needs to be reimbursed; or, it might be viewed as the incentive for the subject to participate in the experiment; or, it might be the inherent value of the data.

This economic aspect has always been inherent in experimental design: experimenters often work within strict budgets and design creative incentives. However, a principled study of this setting from a strategic point of view is not well known. When subjects are strategic, they may have an incentive to misreport their cost and the choice of experiments and payments need to be more sophisticated.

The problem of experimental design subject to a given budget exists in the presence of strategic agents who may lie about their costs. In particular, the present principles focus on linear regression. This is naturally viewed as a budget feasible mechanism design problem, in which the objective function is related to the covariance of the xi's. In particular, the Experimental Design Problem (EDP) is formulated as follows: the experimenter E wishes to find a set S of subjects to maximize

$$V ( S ) = log det ( {I}_{d} + {\sum }_{i ∈ S} {x}_{i} {x}_{i}^{T} )$$

subject to a budget constraint

$${\sum }_{i ∈ S} {c}_{i} \leq B ,$$

where B is E's budget. The objective function, which is the key, is obtained by optimizing the information gain in β when it is learned through linear regression methods, and is related to the so-called D-optimality criterion. The above objective is submodular.

The method proposed herein operates as follows:
For each subject i, an input a vector xᵢ is received describing the public features of the subject (age or gender, for example) as well as a cost cᵢ, describing their desired compensation for participating in the experiment
From the experimenter, a budget B is received describing the amount of money it can spend on the experiment
To each set of subjects S, a value function V(S) is found, given by

V(S)=log det(I+Σ_{i in s} xᵢxᵢ^{T})

which captures how useful the result of the specific experiment is, and computes the values for the individual subjects of each set.
A decision is made regarding from which users to purchase data using the algorithm described in Algorithm 1. In short:
   Given these values as input, it computes a threshold value ξ as a solution to an optimization problem
   If the value V(i*) of the most valuable subject is higher than Cξ, for a constant C, the experimenter simply conducts the experiment on this most valuable user, and gives her the entire budget B.
   If not, the experimenter constructs the set of subjects to experiment upon in increasing order of their marginal contribution to the value function V, as described in algorithm 1, and compensates them using so-called threshold payments.

Algorithm 1 Mechanism for EDP

| | |
|---|---|
| 1: | N ← N \ {i ε N : cᵢ >B} |
| 2: | i* ← arg max_{jεN} V(j) |
| 3: | ξ ← arg max_{λε[0,1]}ⁿ{L(λ) \| λ_{i*} = 0₁Σ_{iεN\{i*}}cᵢλᵢ ≦ B} |
| 4: | if L(ξ) < C · V(i*) then |
| 5: | return (i*) |
| 6: | else |
| 7: | $i ← arg {max}_{1 \leq j \leq n} \frac{V ( j )}{cj}$ |
| 8: | S_{G} ← |
| 9: | $while {c}_{i} \leq \frac{B}{2} \frac{V ( {S}_{G} ⋃ \{ i \} ) - V ( {S}_{G} )}{V ( {S}_{G} ⋃ \{ i \} )} do$ |
| 10: | S_{G} ← S_{G} ∪ {i} |
| 11: | $i ← arg {max}_{j ∈ 𝒩 \backslash {S}_{G}} \frac{V ( {S}_{G} ⋃ \{ j \} ) - V ( {S}_{G} )}{cj}$ |
| 12: | end while |
| 13: | return S_{G} |
| 14: | end if |

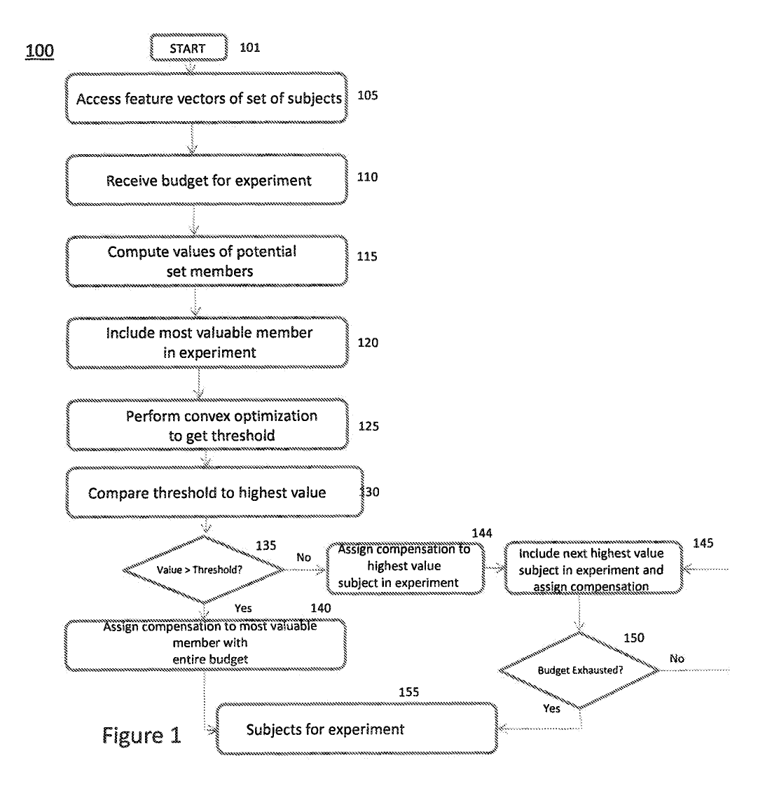

One embodiment of a method 100 for designing a data market under the present principles is shown in the flow diagram of FIG. 1. The method begins at start block 101 and control proceeds to accessing feature vectors of members of a set of possible subjects in block 105. The feature vectors may be comprised of public features of the set members. These features could be age or gender, for example. The feature vectors may also comprise desired compensation information of the particular member. This is the amount of compensation that is needed to get the member to participate in the experiment. Following block 105, control proceeds to block 110 for receiving a budget for the experiment. This is the total that is to be spent to conduct the experiment or survey, that is, the total to be spent to compensate all of the selected participants in the experiment. Following block 110, control proceeds to block 115 for computing the values of each of the members in the set of potential subjects for the experiment and the value function V(s). The individual subjects' values are based on the desired compensation of each member of the set which may be included in the feature vectors for each member. The values may be computed using the D-optimality criterion. Control then proceeds to block 120 for including the member with the highest value in the set of subjects for the experiment. Following block 120, control proceeds to block 125 for performing convex optimization on the remaining members of the set of potential subjects for the experiment to determine a threshold, to be used in evaluating whether additional subjects will be used in the experiment. Following block 125, control then proceeds to block 130 for comparing the threshold to the value of the aforementioned member that had the highest value among the potential subjects and is already included in the experiment. Following block 130, control then proceeds to block 135 for comparing this value against the threshold. If the value of the first member included in the experiment (the highest value among all potential subjects) is greater than the threshold, then control proceeds to block 140 and the first member is assigned compensation with the entire budget devoted to the experiment. If, however, the value of the first member included in the experiment is not greater than the threshold, the first member is assigned compensation with an amount necessary to have that member included in the experiment in block 144 and then control proceeds to block 145 in which the next highest value member of potential subjects is added to the experiment and assigned compensation with an amount necessary to be included in the experiment. Following block 145, control proceeds to block 150 that determines whether the budget has been exhausted. If the budget has not been exhausted, blocks 145 and 150 are repeated, adding additional subjects to the experiment one by one until the budget has been exhausted, as checked in block 150. Following blocks 140 or 150, control then proceeds to block 155 in which the subjects for the experiment, and their corresponding compensation values are determined.

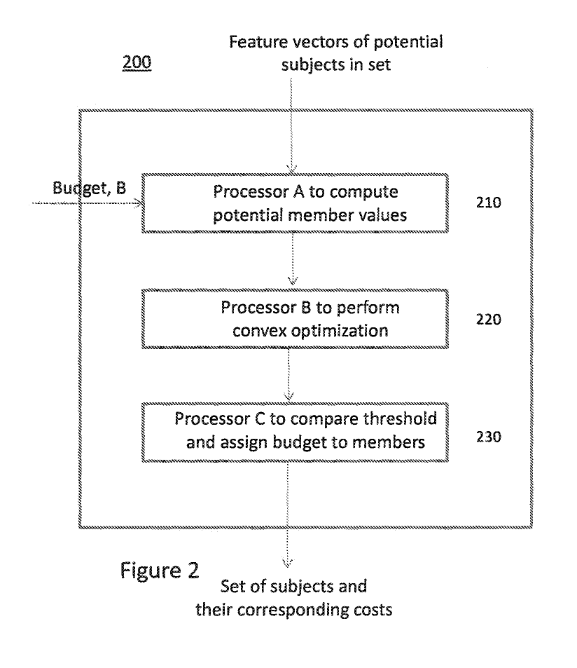

One embodiment of an apparatus 200 for designing a data market under the present principles is shown in FIG. 2. The apparatus implements the method of FIG. 1. The apparatus 200 may be comprised of one or more processors as standalone or integrated units, configured to implement the functions described. The apparatus 200 is shown in FIG. 2 as comprising three separate processors for illustrative purposes only and it should be understood that the functions can be implemented in a single processor or a number of separate processors. In FIG. 2, apparatus 200 is shown as being comprised of Processor A, Processor B and Processor C.

Apparatus 200 receives as input a budget for an experiment on its first input and feature vectors for each potential member of a set of subjects for the experiment on its second input. Processor A within Apparatus 200 is shown as receiving these two sets of inputs, which may be sent to Processor A or in response to a request for this data, either by Apparatus 200 or through external control.

Processor A, in this example, implements the function of computing a value for the set and values for each potential member of the set of subjects to the experiment and determining the highest value member of the set. The highest value member is included in the set of subjects for the experiment.

Processor B then performs convex optimization on the remaining potential members of the set to determine a threshold. Processor C then compares this threshold with the value of the already included, most valuable member of the set of subjects. If the value of the most valuable subject is greater than this threshold, the entire budget for the experiment is devoted to the most valuable subject and the experiment will be conducted with that subject and the entire budget is assigned to him/her. If the value of the most valuable subject is not greater than the threshold, the most valuable member is assigned compensation in accordance with its desired compensation, and the next most valuable member of the potential subjects is included in the experiment and assigned a threshold payment necessary to be included in the experiment. The processor checks whether the budget is exhausted. If not, the processor(s) continue to add subjects to the experiment one by one, assigning compensation to each with the amount needed for them to participate in the experiment, and checks if the budget is exhausted following each inclusion. When the budget is exhausted, the set of potential subjects and their corresponding payments, is complete.

A more general discussion follows from a perspective of information gain. A budget feasible reverse auction comprises a set of items N={1, . . . , n} as well as a single buyer. Each item has a cost. Moreover, the buyer has a positive value function as well as a budget, B. In the full information case, the costs cᵢ are common knowledge; the objective of the buyer in this context is to select a set S maximizing the value V (S) subject to the constraint that the sum of the costs cᵢ is less than or equal to the budget, B. The optimal value achievable in the full-information case is:

$$OPT = {max}_{S ⊆ 𝒩} \{ V ( S ) \vert {\sum }_{i ∈ S} {x}_{i} \leq B \}$$

In the strategic case, each item in N is held by a different strategic agent, whose cost is a priori private. A mechanism M=(f; p) comprises (a) an allocation function f and (b) a payment function p. Given the vector of costs c=[ci], the allocation function f determines the set in N of items to be purchased, while the payment function returns a vector of payments [pi]. Let sᵢ(c) be the binary indicator of i. As in previous approaches, the present description describes mechanisms that are normalized (so that pᵢ(c)=0), individually rational (pᵢ(c)≧cᵢ _{_{—}}sᵢ(c)) and have no positive transfers (pᵢ(c)≧0). In addition to the above, mechanism design in budget feasible reverse auctions seeks mechanisms that have the following properties:
1. Truthfulness: An agent has no incentive to misreport the agent's true cost.
2. Budget Feasibility. The sum of the payments should not exceed the budget constraint.
3. Approximation ratio. The value of the allocated set should not be too far from the optimum value of the full information case. Formally, there must exist some α≧1 such that OPT≦αV(S). The approximation ratio captures the price of truthfulness, i.e., the relative value loss incurred by adding the truthfulness constraint.
4. Computational efficiency: The allocation and payment function should be computable in polynomial time in the number of agents n.

Budget feasible reverse auctions are single parameter auctions: each agent has only one private value. In this case, Myerson's Theorem gives a characterization of truthful mechanisms. Myerson's Theorem allows the focus to be on designing a monotone allocation function. Then, the mechanism will be truthful as long as the mechanism gives each subject their threshold payment, under the constraint that the payments need to sum to a value below B.

The problem of optimal experimental design is considered from the perspective of a budget feasible reverse auction, as defined above. In particular, assume the experimenter E has a budget B and plays the role of the buyer. Each experiment i [symbol] N corresponds to a strategic agent, whose cost cᵢ is private. In order to obtain the measurement yᵢ, the experimenter needs to pay agent i a price that exceeds her cost.

For example, each i may correspond to a human subject; the feature vector xᵢ may correspond to a normalized vector of her age, weight, gender, income, etc., and the measurement yᵢ may capture some biometric information (e.g., her red cell blood count, a genetic marker, etc.). The cost cᵢ is the amount the subject deems sufficient to incentivize her participation in the study. Note that, in this setup, the feature vectors xᵢ are public information that the experimenter can consult prior to the experiment design. Moreover, though a subject may lie about her true cost cᵢ, she cannot lie about xᵢ (i.e., all features are verifiable upon collection) or yᵢ (i.e., she cannot falsify her measurement). If she does lie about her true cost, she may not be selected to participate in the experiment because her value to the experiment will be diminished at the higher cost.

Ideally, motivated by the D-optimality criterion, one goal of the present principles is a mechanism that maximizes

$$V ( S ) = \frac{1}{2} log det {X}_{S}^{T} {X}_{S}$$

within a good approximation ratio. In what follows, a slightly more general objective is considered as follows:

$$EXPERIMENTALDESIGNPROBLEM ( E D P )$$

$$Maximize V ( S ) = log det ( {I}_{d} + {X}_{S}^{T} {X}_{S} )$$

$$subject to {\sum }_{i ∈ S} {c}_{i} \leq B$$

where I_{d}∈R^{d×d} is the identity matrix.

The resulting mechanism for EDP is composed of the allocation function presented in Algorithm 1 and the payment function which pays each allocated agent I her threshold payment as described in Myerson's Theorem. In the case where {i*} is the allocated set, her threshold payment is B (she would have been dropped on line 1 of Algorithm 1 had she reported a higher cost). In the case where S_{G} is the allocated set, threshold payments' characterization gives a formula to compute these payments. Algorithm 1 gives the main result for the Experimental Design Problem.

The previous results can be extended to a more general Bayesian case, in which an experimenter is assumed to have a prior distribution on β. Maximization in this case using ridge regression leads to:

$$\tilde{β} = {arg min}_{β ∈ {R}^{A}} {\sum }_{i} {( {y}_{i} - {β}^{T} {x}_{i} )}^{2} + {β}^{T} R β$$

If H(β) is the entropy of β under this distribution and H(β|yₛ) is the entropy of β conditioned on the experiment outcomes, a set of experiments can be chosen to maximize the information gain:

I(β; ys)=H(β)−H(β|ys)¹

which is equivalent to

$$V ( S ) = \frac{1}{2} log det ( R + {X}_{S}^{T} {X}_{S} )$$

which, for a general Bayesian case, yields:

$$\begin{matrix}\tilde{V} ( S ) = \frac{1}{2} log det ( R + {X}_{S}^{T} {X}_{S} ) - \frac{1}{2} log det R \\ = \frac{1}{2} log det ( {I}_{A} + {R}^{- 1} {X}_{S}^{T} {X}_{S} )\end{matrix}$$

One embodiment of a method to implement this principle is to receive data comprising features of a subject, and a cost to include this subject in the experiment. The method further assigns a budget that can be spent on the experiment.

A value function is associated with each of the subjects that represents the usefulness of the result of the specific experiment with that particular subject.

The method then determines based on Algorithm 1, a threshold value as a solution to an optimization problem. This threshold value is compared to the value function for each subject.

If the value of the most valuable subject is higher than Cξ, for a constant C, the experiment is conducted using only this most valuable user, and gives the entire budget to this subject.

If however, the value of the most valuable subject is not higher than Cξ, the experiment uses the set of subjects in increasing order of their marginal contribution to the value function V and devotes the amount of the budget to them using threshold payments.

Actions relating to which subjects to use and the budget assigned to them are made responsive to a transformation of data under the present principles and representative of the subjects and the assigned budgets. Data representing the subjects that are used for the experiment and the amount of budget assigned to the subject or subjects is used to transform additional data or cause additional actions.

One or more implementations having particular features and aspects of the presently preferred embodiments of the invention have been provided. However, features and aspects of described implementations can also be adapted for other implementations. For example, these implementations and features can be used in the context of other video devices or systems. The implementations and features need not be used in a standard.

Reference in the specification to “one embodiment” or “an embodiment” or “one implementation” or “an implementation” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

The implementations described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or computer software program). An apparatus can be implemented in, for example, appropriate hardware, software, and firmware. The methods can be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein can be embodied in a variety of different equipment or applications. Examples of such equipment include a web server, a laptop, a personal computer, a cell phone, a PDA, and other communication devices. As should be clear, the equipment can be mobile and even installed in a mobile vehicle.

Additionally, the methods can be implemented by instructions being performed by a processor, and such instructions (and/or data values produced by an implementation) can be stored on a processor-readable medium such as, for example, an integrated circuit, a software carrier or other storage device such as, for example, a hard disk, a compact disc, a random access memory (“RAM”), or a read-only memory (“ROM”). The instructions can form an application program tangibly embodied on a processor-readable medium. Instructions can be, for example, in hardware, firmware, software, or a combination. Instructions can be found in, for example, an operating system, a separate application, or a combination of the two. A processor can be characterized, therefore, as, for example, both a device configured to carry out a process and a device that includes a processor-readable medium (such as a storage device) having instructions for carrying out a process. Further, a processor-readable medium can store, in addition to or in lieu of instructions, data values produced by an implementation.

As will be evident to one of skill in the art, implementations can use all or part of the approaches described herein. The implementations can include, for example, instructions for performing a method, or data produced by one of the described embodiments.

A number of implementations have been described. Nevertheless, it will be understood that various modifications can be made. For example, elements of different implementations can be combined, supplemented, modified, or removed to produce other implementations. Additionally, one of ordinary skill will understand that other structures and processes can be substituted for those disclosed and the resulting implementations will perform at least substantially the same function(s), in at least substantially the same way(s), to achieve at least substantially the same result(s) as the implementations disclosed. Accordingly, these and other implementations are contemplated by this disclosure and are within the scope of these principles.

1. A method of selecting subjects from which to gather data from a set of potential subjects, comprising:
accessing a vector of features of at least one subject, comprising a cost of the at least one subject to participate;
receiving a budget describing a cost to spend for the subjects;
computing a value for each member of the set of potential subjects to determine the highest value member of the set and adding this member to a list of subjects to participate;
performing convex optimization on subjects in the set, other than the highest value member of the set, to determine a threshold;
comparing said threshold to said computed value to determine whether said computed value exceeds said threshold, and if so,
assigning compensation to the at least one subject with the entire budget, and if said computed value does not exceed said threshold,
assigning portions of said budget proportionally to subjects added to the list of subjects to participate in increasing order of their marginal contribution to value for participating, until said budget is exhausted.

2. The method of claim 1, wherein said vector of features comprises age and gender.

3. The method of claim 1, wherein said value is the D-optimality criterion.

4. The method of claim 1, wherein said second assigning step comprises iteratively adding one subject at a time to the list of subjects to participate.

5. The method of claim 4, wherein the subject added at each iteration has the greatest ratio of value to cost to participate in the experiment.

6. An apparatus, comprising:
one or more processors for selecting subjects from which to gather data from a set of potential subjects, collectively configured to:
access a vector of features of at least one subject, comprising a cost of the at least one subject to participate;
receive a budget describing a cost to spend for the subjects;
compute a value for each member of the set of potential subjects to determine the highest value member of the set and adding this member to a list of subjects to participate;
perform convex optimization on subjects in the set other than the highest value member of the set to determine a threshold;
compare said threshold to said computed value to determine whether said computed value exceeds said threshold, and if so,
assign compensation to the at least one subject with the entire budget, and if said computed value does not exceed said threshold,
assign portions of said budget proportionally to subjects added to the list of subjects to participate in increasing order of their marginal contribution to value for participating, until said budget is exhausted.

7. The apparatus of claim 6, wherein said vector of features comprises age and gender.

8. The apparatus of claim 6, wherein said value is the D-optimality criterion.

9. The apparatus of claim 6, wherein said second assigning step comprises iteratively adding one subject at a time to the the list of subjects to participate.

10. The apparatus of claim 9, wherein the subject added at each iteration has the greatest ratio of value to cost to participate in the experiment.

11. The method of claim 1, wherein the subjects are selected to participate in an experiment.

12. The method of claim 1, wherein the subjects are selected to participate in a market survey.

13. The method of claim 1, wherein the subjects are selected to participate in a medical research study.

14. The apparatus of claim 6, wherein the subjects are selected to participate in an experiment.

15. The apparatus of claim 6, wherein the subjects are selected to participate in a market survey.

16. The apparatus of claim 6, wherein the subjects are selected to participate in a medical research study.
